(19) United States
(12) Patent Application Publication
(10) Pub. No.: US 2012/0188305 A1
(43) Pub. Date: Jul. 26, 2012

(54) INK JET RECORDING METHOD

(75) Inventor: Shohei SHIONO, Matsumoto (JP)

(73) Assignee: Seiko Epson Corporation, Tokyo (JP)

(21) Appl. No.: 13/351,453

(22) Filed: Jan. 17, 2012

(30) Foreign Application Priority Data
Jan. 20, 2011 (JP) 2011-009480

(51) Int. Cl. B41J 2/015

(52) U.S. Cl. 347/20

(57) ABSTRACT

An ink jet recording method according to this invention includes an ejection process of ejecting liquid droplets of a white ink composition to a swelling type target recording medium, in which the white ink composition contains a fluorene resin, a styrene acrylic resin, titanium dioxide particles, and water, the fluorene resin is contained in a proportion of 1% by mass or more and 16% by mass or lower based on the total mass of the white ink composition, the target recording medium has a resin layer containing a hydrophilic resin, and the liquid droplets of the white ink composition are ejected to the resin layer in the ejection process.

Priority is claimed under 35 U.S.C. §119 to Japanese Application No. 2011-009480 filed on Jan. 20, 2011, is hereby incorporated by reference in its entirety.

### BACKGROUND

1. Technical Field

The present invention relates to an ink jet recording method using a white ink composition.

2. Related Art

Heretofore, white ink compositions containing white pigments, such as metal oxides, such as titanium dioxide, zinc oxide, silica, alumina, and magnesium oxide, barium sulfate, or calcium carbonate, have been used in various recording methods.

For example, JP-A-6-322306 discloses white ink compositions containing titanium dioxide for use in ink jet recording devices. Such white ink compositions for use in ink jet recording devices adhere to a target recording medium by being ejected from a recording head to form an image on the target recording medium similarly as in other color ink compositions. Therefore, the white ink compositions are required to have good ejection stability from an ink jet recording head, for example.

However, when an image is recorded with the above-described white ink compositions, an image having an insufficient whiteness degree is recorded in some cases depending on the type of the target recording medium to be used.

### SUMMARY

An advantage of some aspects of the invention is to provide an ink jet recording method which has good ejection stability and allows recording of an image having a good whiteness degree.

The invention has been made in order to at least partially solve the above-described problem and can be realized as the following embodiments or application examples.

### APPLICATION EXAMPLE 1

One aspect of an ink jet recording method according to the invention, includes an ejection process of ejecting liquid droplets of a white ink composition to a swelling type target recording medium, in which the white ink composition contains a fluorene resin, a styrene acrylic resin, titanium dioxide particles, and water.

According to the aspect of the first application example, the ejection stability of the white ink composition is excellent and an image with an excellent whiteness degree can be recorded.

### APPLICATION EXAMPLE 2

In the application example 1, the target recording medium has a resin layer containing a hydrophilic resin, and the liquid droplets of the white ink composition can be ejected to the resin layer in the ejection process.

### APPLICATION EXAMPLE 3

In the application example 2, the hydrophilic resin can be a urethane resin or a cellulose resin.

### APPLICATION EXAMPLE 4

In the application example 2, the hydrophilic resin can be a urethane resin.

### APPLICATION EXAMPLE 5

In the application example 3, the urethane resin can be a cationic urethane resin.

### APPLICATION EXAMPLE 6

In the application example 3, the urethane resin or the cellulose resin can occupy 80% by mass or more of constituent components of the resin layer.

### APPLICATION EXAMPLE 7

In any one of the application examples 2 to 6, the target recording medium has a support layer, the resin layer is formed on at least one side of the support layer, and the water absorptivity of the support layer can be lower than the water absorptivity of the resin layer.

### APPLICATION EXAMPLE 8

In any one of the application examples 1 to 7, the styrene acrylic resin can be contained in a proportion of 1% by mass or more and 10% by mass or lower based on the total mass of the white ink composition.

### DESCRIPTION OF EXEMPLARY EMBODIMENTS

Hereinafter, preferable embodiments of the invention are described. The embodiments described below describe one example of the invention. The invention is not limited to the following embodiments and also includes various modifications carried out in the range in which the scope of the invention is not altered.

### 1. WHITE INK COMPOSITION

First, a white ink composition for use in an ink jet recording method according to a first embodiment of the invention is described. The white ink composition according to this embodiment contains a fluorene resin, a styrene acrylic resin, a white pigment, and water.

### 1.1. Fluorene Resin

The white ink composition according to this embodiment contains a fluorene resin. Mentioned as one of the functions of the fluorene resin is to promote the condensation of titanium dioxide particles when the white ink composition is ejected to a target recording medium described later to thereby increase the whiteness degree of an image formed on the target recording medium.

The fluorene resin is not particularly limited insofar as the resin has a fluorene skeleton and can be obtained by copolymerizing the following monomer units (a) to (d), for example:
(a) Isophorone diisocyanate (CAS No. 4098-71-9);
(b) 4,4′-(9-fluorenylidene)bis[2-(phenoxy)ethanol] (CAS No. 117344-32-8);
(c) 3-hydroxy-2-(hydroxymethyl)-2-methylpropionic acid (CAS No. 4767-03-7); and
(d) Triethylamine (CAS No. 121-44-8).

The fluorene resin for use in the invention is not particularly limited insofar as the resin contains a monomer having a fluorene skeleton represented by 4,4′-(9-fluorenylidene)bis[2-(phenoxy)ethanol] (CAS No. 117344-32-8).

The content (solid content) of the fluorene resin is 0.5% by mass or more and 16% by mass or lower and preferably 1% by mass or more and 16% by mass or lower and preferably 10% by mass or more and 16% by mass or lower based on the total mass of the white ink composition. When the content of the fluorene resin is within the range mentioned above, the ejection stability of an ink jet recording head is good and a good image having a high whiteness degree can be recorded. In contrast, when the content of the fluorene resin exceeds the range mentioned above, the ejection stability of an ink jet recording head decreases in some cases. When the content of the fluorene resin is lower than the range mentioned above, an image having an insufficient whiteness degree is formed in some cases.

### 1.2. Styrene Acrylic Resin

The white ink composition according to this embodiment contains a styrene acrylic resin. Mentioned as one of the functions of the styrene acrylic resin is to increase the dispersibility of a white pigment. When both the styrene acrylic resin and the fluorene resin are contained in the white ink composition according to this embodiment, the whiteness degree of an image formed on a target recording medium can be further increased by the synergistic effect of these components.

Mentioned as the styrene acrylic resin are, for example, a styrene-acrylic acid copolymer, a styrene-methacrylic acid copolymer, a styrene-methacrylic acid-acrylic acid ester copolymer, a styrene-α-methylstyrene-acrylic acid copolymer, a styrene-α-methylstyrene-acrylic acid-acrylic acid ester copolymer, and the like. As the form of the copolymers, any form of a random copolymer, a block copolymer, an alternating copolymer, and a graft copolymer can be used.

As the styrene acrylic resin, commercially available one may be utilized. As a commercially available item of the styrene acrylic resin, JONCRYL 62J (manufactured by Basf Japan, Inc.) and the like are mentioned as a specific example.

The content (solid content) of the styrene acrylic resin is preferably 1% by mass or more and 10% by mass or lower, more preferably 3% by mass or more and 7% by mass or lower, and particularly preferably 4% by mass or more and 6% by mass or lower based on the total mass of the white ink composition. When the content of the styrene acrylic resin is within the range mentioned above, the dispersibility of the white pigment contained in the white ink composition becomes good, so that the ejection stability of an ink jet recording head can be further increased. In contrast, when the content of the styrene acrylic resin exceeds the range mentioned above, the viscosity of the white ink composition increases, so that ink is difficult to be ejected from an ink jet recording head. When the content of the styrene acrylic resin is lower than the range mentioned above, the dispersibility of the white pigment contained in the white ink composition decreases, so that the ejection stability of an ink jet recording head decreases or an image having an insufficient whiteness degree is formed in some cases.

### 1.3. White Pigment

The white ink composition according to this embodiment contains a white pigment. Mentioned as the white pigment are metal oxide, barium sulfate, calcium carbonate, and the like, for example. Mentioned as the metal oxide are titanium dioxide, zinc oxide, silica, alumina, magnesium oxide, and the like, for example. As the white pigment contained in the white ink composition of this embodiment, titanium dioxide is preferable in terms of excellent whiteness degree. The content (solid content) of the white pigment is preferably 1% by mass or more and 20% by mass or lower and more preferably 5% by mass or more and 15% by mass or lower based on the total mass of the white ink composition. When the content of the white pigment exceeds the range mentioned above, an ink jet recording head is clogged, which deteriorates the reliability in some cases. In contrast, when the content of the white pigment is lower than the range mentioned above, there is a tendency that the color concentration, such as a whiteness degree, becomes insufficient in some cases.

When titanium dioxide particles are used as the white pigment, the average particle diameter based on the volume (hereinafter referred to as “average particle diameter”) of the titanium dioxide particles is preferably 30 nm or more and 600 nm or lower and more preferably 200 nm or more and 400 nm or lower. When the average particle diameter of the titanium dioxide particles exceeds the range mentioned above, the titanium dioxide particles precipitate, for example, to deteriorate the dispersion stability or an ink jet recording head is clogged, for example, to deteriorate the reliability in some cases. In contrast, when the average particle diameter of the titanium dioxide particles is lower than the range mentioned above, there is a tendency that the whiteness degree becomes insufficient.

The average particle diameter of the titanium dioxide particles can be measured by a particle size distribution meter employing a laser diffraction scattering method as the measurement principle. Mentioned as the particle size distribution meter is, for example, a particle size distribution meter (e.g., “MICROTRACK UPA”, manufactured by Nikkiso Co., Ltd.) employing a dynamic light scattering method as the measurement principle.

In the invention, the “white ink composition” refers to one in which the brightness (L*) and the chromaticity (a*, b*) of the ink ejected to Epson genuine photo paper <glossy> (manufactured by Seiko Epson Corporation) with a duty of 100% or more are in the ranges of 70≦L*≦100, −4.5≦a*≦2, and −6≦b*≦2.5 when measured using a spectrophotometer, Spectrolino (trade name, manufactured by GretagMacbeth) by setting the measurement conditions as follows: D50 light source, a field of view of 2°, a concentration of DINNB, a white standard of Abs, a filter of No, and a measurement mode of Reflectance.

In this specification, the “duty value” is a value calculated by the following formula.

Duty(%)=Number of actually ejected dots/(Vertical resolution×Horizontal resolution)×100

(In the formula, the “Number of actually ejected dots” is the number of actually ejected dots per unit area and the “Vertical resolution” and the “Horizontal resolution” each are the resolution per unit area.)

### 1.4. Water

The white ink composition according to this embodiment contains water. The water in the white ink composition can swell a resin layer of a swelling type target recording medium described later. Thus, an image having excellent fixability can be recorded on the swelling type target recording medium.

The content of the water is preferably 50% by mass or more based on the total mass of the white ink composition. Thus, the resin layer of the swelling type target recording medium can be easily swollen.

An aqueous ink containing water as the main solvent has lower reactivity with piezoelectric elements and the like used in ink jet recording heads compared with a non-aqueous (solvent-based) ink (e.g., refer to the ink disclosed in JP-A-2007-16103 as ink for use in a recorded material), and therefore dissolving or corroding the piezoelectric elements can be suppressed in some cases. Moreover, the aqueous ink can form an image excellent in drying properties in some cases as compared with a non-aqueous ink containing many high boiling point and low viscosity solvents. Furthermore, the aqueous ink has an advantage in that a bad order is also suppressed as compared with the solvent based ink.

### 1.5. Other Components

The white ink composition according to this embodiment can contain an organic solvent. The white ink composition may contain a plurality of kinds of organic solvents. Mentioned as the organic solvent for use in the white ink composition are 1,2-alkanediols, polyhydric alcohols, pyrrolidone derivatives, and the like.

Mentioned as the 1,2-alkanediols are, for example, 1,2-propanediol, 1,2-butanediol, 1,2-pentanediol, 1,2-hexanediol, 1,2-octanediol, and the like. Since the 1,2-alkanediols are excellent in the action of increasing the wettability of the white ink composition to a target recording medium for uniformly weting, a good image can be formed on a target recording medium. When the 1,2-alkanediols are contained, the content thereof is preferably 1% by mass more than and 20% by mass or lower based on the total mass of the white ink composition.

Mentioned as the polyhydric alcohols are, for example, ethylene glycol, diethylene glycol, propylene glycol, dipropyrene glycol, 1,3-propanediol, 1,4-butanediol, 1,6-hexanediol, glycerin, and the like. The polyhydric alcohols can be preferably used from the viewpoint of suppressing drying and solidification of the ink at the nozzle surface of an ink jet recording head to reduce clogging or poor ejection. When the polyhydric alcohols are contained, the content thereof is preferably 2% by mass or more and 20% by mass or lower based on the total mass of the white ink composition.

Mentioned as the pyrrolidone derivatives are, for example, N-methyl-2-pyrrolidone, N-ethyl-2-pyrrolidone, N-vinyl-2-pyrrolidone, 2-pyrrolidone, N-butyl-2-pyrrolidone, 5-methyl-2-pyrrolidone, and the like. The pyrrolidone derivatives can act as a good solubilizer of resin components, such as styrene acrylic resin. When the pyrrolidone derivatives are contained, the content thereof is preferably 3% by mass or more and 25% by mass or lower based on the total mass of the white ink composition.

Moreover, the white ink composition according to this embodiment can contain a surfactant. Mentioned as the surfactant are a silicon surfactant, an acetylene glycol surfactant, and the like.

As the silicon surfactant, a polysiloxane compound and the like are preferably used and, for example, a polyether-modified organosiloxane and the like are mentioned. In more detail, mentioned are BYK-306, BYK-307, BYK-333, BYK-341, BYK-345, BYK-346, and BYK-348 (all trade names, manufactured by BYK-Chemie Japan K.K.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all trade names, manufactured by Shin-Etsu Chemicals Co., Ltd.), and the like. The silicon surfactant can be preferably used from the viewpoint of having the action of uniformly spreading the white ink without causing concentration unevenness or bleeding of the white ink on a target recording medium. When the silicon surfactant is contained, the content is preferably 0.1% by mass or more and 1.5% by mass or lower based on the total mass of the white ink composition.

Mentioned as the acetylene glycol surfactants are, for example, Surfinols 104, 104E, 104H, 104A, 104BC, 104DPM, 104PA, 104PG-50, 104S, 420, 440, 465, 485, SE, SE-F, 504, 61, DF37, DF110D, CT111, CT121, CT131, CT136, TG, and GA (all trade names, manufactured by Air Products and Chemicals. Inc.), Olfines B, Y, P, A, STG, SPC, E1004, E1010, PD-001, PD-002W, PD-003, PD-004, EXP.4001, EXP.4036, EXP.4051, AF-103, AF-104, AK-02, SK-14, and AE-3 (all trade names, manufactured by Nisshin Chemical Co., Ltd.), acetylenols E00, E00P, E40, and E100 (all trade names, manufactured Kawaken Fine Chemicals Co., Ltd.), and the like. The acetylene glycol surfactant has a property such that the capability to appropriately keep surface tension and interfacial tension is excellent and almost no foamability is imparted, as compared with other surfactants. When the acetylene surfactant is contained, the content is preferably 0.1% by mass or more and 1.0% by mass or lower based on the total mass of the white ink composition.

Moreover, the white ink composition according to this embodiment can contain saccharides. Mentioned as the saccharides are monosaccharides, oligosaccharides, and polysaccharides. For example, mentioned are glucose, mannose, galactose, fucose, ribose, fructose, xylose, arabinose, maltose, cellobiose, lactose, sucrose, trehalose, raffinose, panose, ylmaltose, stachyose, gentiobiose, gentianose and the like. The saccharides can be preferably used in terms of having the action of suppressing drying and solidification of the ink at the nozzle surface of an ink jet recording head to prevent clogging or poor ejection. When the saccharides are contained, the content thereof is preferably 1% by mass or more and 20% by mass or lower based on the total mass of the white ink composition.

The white ink composition according to this embodiment can further contain a pH adjuster, an antiseptic agent, an antifungal agent, a rust-preventive agent, a chelating agent, and the like. When the white ink composition according to this embodiment contains these compounds, the properties thereof are further increased in some cases.

Mentioned as the pH adjuster are, for example potassium dihydrogenphosphate, disodium hydrogen phosphate, sodium hydroxide, lithium hydroxide, potassium hydroxide, ammonia, diethanolamine, triethanolamine, triisopropanolamine, potassium carbonate, sodium carbonate, sodium hydrogencarbonate, and the like.

Mentioned as the antiseptic agent and the antifungal agent are, for example, sodium benzoate, sodium pentachlorophenol, sodium 2-pyridinethiol-1-oxide, sodium sorbate, sodium dehydroacetate, 1,2-dibenzisothiazolin-3-one, and the like. Mentioned as commercially available items are proxel XL2 and proxel GXL (all trade names, manufactured by Avecia), Denicide CSA and NS-500W (all trade names, manufactured by Nagase ChemteX Corp.), and the like.

As the rust-preventive agent, benzotriazole and the like are mentioned, for example.

Mentioned as the chelating agent are, for example, ethylenediamine tetraacetic acid, a salt thereof (e.g., ethylenediamine tetraacetic acid disodium dihydrate), and the like.

The white ink composition according to this embodiment can be prepared similarly as a former pigment ink using known devices, e.g., a ball mill, a sand mill, an attritor, a basket mill, a roll mill, or the like. In preparing the same, it is preferable to use a membrane filter, a mesh filter, or the like to remove coarse particles.

### 1.6. Physical Properties of White Ink Composition

The viscosity at 20° C. of the white ink composition according to this embodiment is preferably 2 mPa·s or more and 10 mPa·s or lower and more preferably 3 mPa·s or more and 6 mPa·s or lower. When the white ink composition has a viscosity at 20° C. in the range mentioned above, an appropriate amount thereof is ejected from a nozzle, and curved flight or scattering can be further reduced. Therefore, the white ink composition can be preferably used in ink jet recording devices. The viscosity of the white ink composition can be measured using a vibration viscometer VM-100AL (manufactured by Yamaichi Electronics, Inc.) by maintaining the temperature of the white ink composition at 20° C.

### 1.7. Effect of Action

Since the white ink composition for use in an ink jet recording method according to this embodiment contains the components mentioned above, an image having a whiteness degree equivalent to that of a former white ink composition can be recorded on a void type target recording medium and also an image having a whiteness degree equivalent to that of the image formed on the void type target recording medium can be recorded also on a swelling type target recording medium. Thus, the white ink composition for use in an ink jet recording method according to this embodiment can record an image having a good whiteness degree on various types of target recording media.

In the invention, the void type target recording medium refers to one which is configured so that the surface to which ink is ejected does not contain a hydrophilic resin as the main component and contains inorganic particles as the main component and liquid permeates into the space between the inorganic particles or into the voids of pores provided in the inorganic particles. In the invention, the swelling type target recording medium refers to one which is configured so that resin occupies 70 percent or more of the components constituting the swelling resin layer and the resin layer is swollen by the solvent of the ink, so that the solvent permeates into the pores opened by the swelling.

### 2. TARGET RECORDING MEDIUM

Next, a target recording medium for use in an ink jet recording method according to one embodiment of the invention is described. The target recording medium for use in an ink jet recording method according to this embodiment is a swelling type target recording medium.

The target recording medium according to this embodiment may have a resin layer containing a hydrophilic resin. When the target recording medium has a resin layer, liquid droplets of the white ink composition may be ejected to the resin layer of the target recording medium. The hydrophilic resin contained in the resin layer swells by the moisture contained in the white ink composition, and thus can take in the white ink composition. Thus, the white ink composition is held by the resin layer to be fixed to the target recording medium.

As the hydrophilic resin, a known hydrophilic resin can be utilized and, for example, gelatin, polyvinyl pyrrolidone, polyvinyl alcohol, polyvinyl acetal, a urethane resin, such as a polyester urethane resin, a polyether urethane resin, and a polycarbonate urethane resin, and a cellulose resin, such as carboxymethylcellulose and hydroxyethylcellulose, and the like can be mentioned. Among the above, the hydrophilic resin is preferably the cellulose resin or the urethane resin, more preferably the urethane resin, and still more preferably a cationic urethane resin. Thus, an image having a higher whiteness degree can be recorded.

When the resin layer contains the urethane resin or the cellulose resin as the hydrophilic resin, it is preferable that the urethane resin or the cellulose resin occupies 80% by mass or more of the components constituting the resin layer. Thus, an image having a higher whiteness degree can be recorded.

The target recording medium according to this embodiment may have a support layer. The supporter layer may have a resin layer on at least one side. The support layer also can contain a material whose water absorptivity is lower than that of the resin layer. When the water absorptivity of the support layer is lower than the water absorptivity of the resin layer, the ink composition adhering to one surface of the target recording medium can be prevented from bleeding to the other surface.

Mentioned as the support layer are, for example, films or plates of plastics, such as polyvinyl chloride (PVC), polyethylene (PE), polypropylene (PP), polyethylene terephthalate (PET), and polycarbonate (PC), plates of metals, such as iron, silver, copper, and aluminum, metal plates or plastic films manufactured by vapor deposition of the metals, plates of alloys, such as stainless steel or brass, and the like. The support layer may be one formed by coating base materials, such as paper, with the materials mentioned above.

### 3. RECORDING METHOD

An ink jet recording method according to this embodiment has an ejection process of ejecting liquid droplets of the white ink composition to the swelling type target recording medium. The ink jet recording method according to this embodiment can be implemented using known ink jet recording devices.

The white ink composition ejected onto a target recording medium swells the target recording medium, and then enters the inside of the target recording medium to be fixed therein. Thus, an image containing the white ink composition can be recorded on the target recording medium.

In recording using the white ink composition, there is a tendency that the whiteness degree of a white image recorded on the swelling type target recording medium becomes lower than that of an white image recorded on the void type target recording medium. However, the ink jet recording method according to this embodiment allows recording of a good image in which the reduction in the whiteness degree is suppressed also on the swelling type target recording medium, on which an image having an insufficient whiteness degree is likely to be recorded, by the use of the white ink composition containing the components mentioned above.

### 4. EXAMPLES

Hereinafter, the invention is more specifically described with reference to Examples and Comparative Examples, but the invention is not limited to the Examples.

### 4.1. Preparation of White Ink Composition

A pigment, resin components, a surfactant, an organic solvent, and other components were mixed and stirred with the compounding amount shown in Tables 1 to 3, filtered with a metal filter having a pore size of 5 μm, and degassed using a vacuum pump, thereby obtaining white ink compositions of Examples 1 to 8, Comparative Examples 1 to 6, and Reference Example 1. The unit indicated in Tables 1 to 3 is “% by mass”, and the values of the titanium dioxide particles and the resin components are indicated in terms of the solid content.

For the components shown in Tables 1 to 3, the following substances were used.

### Pigment

Titanium dioxide particles (trade name “NanoTek (R) Slurry”, manufactured by C.I. Kasei, Co., Ltd., a slurry containing titanium dioxide particles having an average particle diameter of 300 nm with a solid content concentration of 15%)

### Resin Component

Styrene acrylic resin (trade name “JONCRYL 62J”, manufactured by Basf Japan, Inc.)
Urethane resin (trade name “Rezamin D-1060”, manufactured by Dainichiseika Color & Chemicals Mfg. Co., Ltd.)
Vinyl chloride resin (“Vinyblan 700” manufactured by Nisshin Chemical Co., Ltd.)

### Surfactant

Polysiloxane surfactant (trade name “BYK-348”, manufactured by BYK-Chemie Japan K.K.) Organic solvent
1,2-hexanediol (manufactured by Mitsubishi Gas Chemical Co., Inc.)

### Other Components

Saccharides (trade name “HS-500”, manufactured by HAYASHIBARA SHOJI, Inc.)
Triethanolamine (manufactured by Nacalai Tesque, pH adjuster)
Ion exchanged water

As the fluorene resin shown in Tables 1 to 3, one obtained by synthesizing as follows was used. The fluorene resin was synthesized by weighing 30 parts by mass of isophorone diisocyanate, 50 parts by mass of 4,4′-(9-fluorenylidene)bis[2-(phenoxy)ethanol], 100 parts by mass of 3-hydroxy-2-(hydroxymethyl)-2-methylpropionic acid, and 30 parts by mass of triethylamine and sufficiently mixing, followed by stirring at 120° C. in the presence of a catalyst for 5 hours. The obtained fluorene resin was a resin having a molecular weight of 3300 in which approximately 50% by mass of 4,4′-(9-fluorenylidene)bis[2-(phenoxy) ethanol] was contained in terms of monomer constituent ratio.

### 4.2. Evaluation of Whiteness Degree

### 4.2.1. Production of Whiteness Degree Evaluation Sample

The obtained white ink compositions were individually charged in each of ink chambers of a cartridge exclusive to an ink jet printer (trade name “PX-G930”, manufactured by Seiko Epson Corporation). Then, the ink cartridge was placed in the printer, and solid pattern images were recorded on a plurality of types of recording media. The solid pattern images were recorded under the conditions of a resolution of 1440×1440 dpi and a duty of 100%.

Only in Example 8, the solid pattern images were recorded with a resolution of 1440×1440 dpi to the ejection limit (the amount at which the white ink composition overflows, so that bleeding occurs) of the recording media 3 to 5. With respect to the ejection limit in that case, a duty of 200% in the target recording medium 3, a duty of 100% in the target recording medium 4, and a duty of 150% in the target recording medium 5.

The target recording media used in the recording of the solid pattern images were as follows.
Target recording medium 1 (trade name “JP-OHP 10A”, manufactured by Sanwa Supply, a void type target recording medium),
Target recording medium 2 (“OHP sheet”, manufactured by Seiko Epson Corporation, a void type target recording medium),
Target Recording medium 3 (a swelling type target recording medium having a hydrophilic cationic-urethane resin layer),
Target recording medium 4 (trade name “VF-1100N”, manufactured by Kokuyo Co., Ltd., a swelling type target recording medium having a hydrophilic urethane resin layer),
Target recording medium 5 (trade name “C3875A”, manufactured by JAPAN HEWLETT PACKARD Co., Ltd., a swelling type target recording medium having a hydrophilic cellulose resin layer).

As the target recording medium 3 above, one produced as follows was used. First, 95% by mass of cationic urethane resin (trade name “HYDRAN CP-7020”, manufactured by DIC, Inc., nonvolatile content of 40% by mass) and 5% by mass of cationized colloidal silica (trade name “ST-AK-L”, manufactured by Nissan Chemical Industries, Ltd.) were mixed and stirred, thereby producing a coat liquid. Then, the obtained coat liquid was applied onto a PET film (trade name “PET50A”, manufactured by LINTEC Corp.), and then dried. Thus, the target recording medium 3 was obtained in which the thickness of a cured coating film containing the coat liquid was 20 μm.

### 4.2.2. Measurement of Whiteness Degree

The L* value (whiteness degree) of the white image recorded on each target recording medium was measured using a spectrophotometer, Spectrolino (trade name, manufactured by GretagMacbeth) under the conditions of D50 light source and a field of view of 2°. The evaluation results are also shown in the following Tables 1 to 3. Among the evaluation results, when the L* value is 74 or more, it can be judged that an image having a good whiteness degree was formed.

The measurement using the spectrophotometer was performed in a state where the surface opposite to the measurement surface of the sample with a black pasteboard. The black pasteboard was created as follows. First, a photo black ink (ICBK33, manufactured by Seiko Epson Corporation) was charged in a black ink chamber of a cartridge exclusive to an ink jet printer (trade name “PX-G930”, manufactured by Seiko Epson Corporation), and the ink cartridge was placed in the printer. Subsequently, the image input data on a software of a PC connected to the printer was set to the conditions of “(R, G, B)=(0, 0, 0)” and “no color correction”. Then, a solid pattern image was recorded on a target recording medium (“photo paper <glossy>”, manufactured by Seiko Epson Corporation). The recording was performed with a resolution of 1440×1440 dpi and a duty of 100%. The black pasteboard thus obtained was used in the measurement of the whiteness degree using a spectrophotometer. When the black pasteboard is used, the L* value is low as compared with the case of using a white pasteboard.

### 4.3. Evaluation of Ejection Stability

The images recorded on the target recording medium 3 in “4.2.1. Production of Whiteness Degree Evaluation Sample” were visually observed for the presence of ejection defects (nozzle skipping), and the ejection stability was evaluated in accordance with the following evaluation criteria. The “nozzle skipping” refers to the fact that ink which is to be usually ejected from a nozzle attached to a print head is not ejected due to nozzle clogging, and the recording results are affected. The evaluation criteria of the ejection stability are as follows. Among the evaluation criteria, “A” and “B” are practically permissible levels. The evaluation results are also shown in the following Tables 1 and 2.
“A”: Occurrence of ejection defects (nozzle skipping) is not observed.
“B”: There is a portion where the solid image is not partially filled.
“C”: Ink was not able to be ejected from a nozzle.

TABLE 1

| White ink composition | | | Example 1 | Example 2 | Example 3 | Example 4 | Example 5 | Example 6 | Example 7 |
|---|---|---|---|---|---|---|---|---|---|
| Pigment | Titanium dioxide particles | | 10.0 | 10.0 | 10.0 | 10.0 | 10.0 | 10.0 | 10.0 |
| Resin | Fluorene resin | | 1.0 | 2.0 | 5.0 | 10.0 | 16.0 | 2.0 | 2.0 |
| component | Urethane resin | | | | | | | | |
| | Vinyl chloride resin | | | | | | | | |
| | Styrene acrylic resin | | 5.0 | 5.0 | 5.0 | 5.0 | 5.0 | 1.0 | 10.0 |
| Surfactant | Polysiloxane surfactant | | 0.5 | 0.5 | 0.5 | 0.5 | 0.5 | 0.5 | 0.5 |
| Organic | 1,2-hexanediol | | 5.0 | 5.0 | 5.0 | 5.0 | 5.0 | 5.0 | 5.0 |
| solvent | | | | | | | | | |
| Others | Saccharides | | 7.0 | 7.0 | 7.0 | 7.0 | 7.0 | 7.0 | 7.0 |
| | Triethanolamine | | 0.8 | 0.8 | 0.8 | 0.8 | 0.8 | 0.8 | 0.8 |
| | Ion exchanged water | | Balance | Balance | Balance | Balance | Balance | Balance | Balance |
| Total amount (% by mass) | | | 100.0 | 100.0 | 100.0 | 100.0 | 100.0 | 100.0 | 100.0 |
| Evaluation | Whiteness | Target recording | 77.1 | 77.0 | 77.7 | 77.6 | 77.6 | 77.2 | 77.3 |
| test results | degree | medium 1 | | | | | | | |
| | | Target recording | 77.0 | 77.2 | 77.2 | 77.0 | 77.1 | 77.0 | 77.4 |
| | | medium 2 | | | | | | | |
| | | Target recording | 75.8 | 76.6 | 76.8 | 77.2 | 77.9 | 74.2 | 76.8 |
| | | medium 3 | | | | | | | |
| | | Target recording | 74.1 | 74.8 | 75.1 | 76.2 | 77.0 | 74.1 | 75.0 |
| | | medium 4 | | | | | | | |
| | | Target recording | 75.9 | 76.5 | 76.8 | 77.4 | 77.7 | 74.3 | 76.4 |
| | | medium 5 | | | | | | | |

| | | | | | | | |
|---|---|---|---|---|---|---|---|
| Ejection stability | A | A | A | A | B | A | B |

TABLE 2

| | | | Comparative | Comparative | Comparative | Comparative | Comparative | Comparative | Reference |
|---|---|---|---|---|---|---|---|---|---|
| White ink composition | | | Example 1 | Example 2 | Example 3 | Example 4 | Example 5 | Example 6 | Example 1 |
| Pigment | Titanium dioxide particles | | 10.0 | 10.0 | 10.0 | 10.0 | 10.0 | 10.0 | 10.0 |
| Resin | Fluorene resin | | | 0.3 | 25.0 | | | 2.0 | 2.0 |
| component | Urethane resin | | | | | 2.0 | | | |
| | Vinyl chloride resin | | | | | | 2.0 | | |
| | Styrene acrylic resin | | 5.0 | 5.0 | 5.0 | 5.0 | 5.0 | | 15.0 |
| Surfactant | Polysiloxane surfactant | | 0.5 | 0.5 | 0.5 | 0.5 | 0.5 | 0.5 | 0.5 |
| Organic | 1,2-hexanediol | | 5.0 | 5.0 | 5.0 | 5.0 | 5.0 | 5.0 | 5.0 |
| solvent | | | | | | | | | |
| Others | Saccharides | | 7.0 | 7.0 | 7.0 | 7.0 | 7.0 | 7.0 | 7.0 |
| | Triethanolamine | | 0.8 | 0.8 | 0.8 | 0.8 | 0.8 | 0.8 | 0.8 |
| | Ion exchanged water | | Balance | Balance | Balance | Balance | Balance | Balance | Balance |
| Total amount (% by mass) | | | 100.0 | 100.0 | 100.0 | 100.0 | 100.0 | 100.0 | 100.0 |
| Evaluation | Whiteness | Target recording | 77.7 | 77.7 | — | 77.4 | 76.6 | 77.4 | — |
| test results | degree | medium 1 | | | | | | | |
| | | Target recording | 76.9 | 77.2 | — | 77.3 | 76.9 | 77.1 | — |
| | | medium 2 | | | | | | | |
| | | Target recording | 70.8 | 71.8 | — | 74.1 | 74.2 | 71.1 | — |
| | | medium 3 | | | | | | | |
| | | Target recording | 71.8 | 72.2 | — | 72.7 | 72.5 | 72.2 | — |
| | | medium 4 | | | | | | | |
| | | Target recording | 72.8 | 73.5 | — | 74.1 | 75.0 | 72.7 | — |
| | | medium 5 | | | | | | | |

| | | | | | | | |
|---|---|---|---|---|---|---|---|
| Ejection stability | A | A | C | A | A | B | C |

TABLE 3

| White ink composition | | | Example 8 |
|---|---|---|---|
| Pigment | Titanium dioxide particles | | 10.0 |
| Resin | Fluorene resin | | 2.0 |
| component | Urethane resin | | |
| | Vinyl chloride resin | | |
| | Styrene acrylic resin | | 5.0 |
| Surfactant | Polysiloxane surfactant | | 0.5 |
| Organic | 1,2-hexanediol | | 5.0 |
| solvent | | | |
| Others | Saccharides | | 7.0 |
| | Triethanolamine | | 0.8 |
| | Ion exchanged water | | Balance |
| Total amount (% by mass) | | | 100.0 |
| Evaluation | Whiteness | Target recording | 83.2 |
| test results | degree | medium 3 | |
| | | Target recording | 74.8 |
| | | medium 4 | |
| | | Target recording | 80.1 |
| | | medium 5 | |

### 4.4. Evaluation Results

As shown in Table 1, according to the ink jet recording methods of Examples 1 to 7, the ejection stability was good and images having a good whiteness degree were recorded on both the void type target recording medium and the swelling type target recording medium.

In Example 8, recording was performed using one having the same composition as that of the white ink composition used in Example 2 at the ejection limit of each of the target recording media 3 to 5. As shown in Table 3, according to the ink jet recording method of Example 8, the target recording medium 3 was a target recording medium which can record an image having the highest whiteness degree. The reason why the target recording medium 3 can record an image having a whiteness degree higher than that of the images recorded on the other swelling type target recording media as described above resides in the fact that the ejection limit of the target recording medium 3 is high, and high duty recording can be performed.

In contrast, as shown in Table 2, according to the ink jet recording method of Comparative Example 1, since the white ink composition did not contain the fluorene resin, images having an insufficient whiteness degree were recorded on the swelling type target recording media.

According to the ink jet recording method of Comparative Example 2, when the content of the fluorene resin in the white ink composition was lower than 1% by mass, images having an insufficient whiteness degree were recorded on the swelling type target recording media.

According to the ink jet recording method of Comparative Example 3, because the content of the fluorene resin in the white ink composition exceeded 16% by mass, the white ink composition was not able to be ejected from the nozzle of the ink jet recording device. According to the ink jet recording method of Comparative Example 3, since the white ink composition was not able to be ejected, the whiteness degree was not able to be evaluated.

According to the ink jet recording methods of Comparative Examples 4 and 5, since the white ink composition did not contain the fluorene resin, images having an insufficient whiteness degree were recorded on the swelling type target recording media.

According to the ink jet recording method of Comparative Example 6, since the white ink composition did not contain the styrene acrylic resin, images having an insufficient whiteness degree were recorded on the swelling type target recording media.

According to the ink jet recording method of Reference Example 1, it was shown that when the content of the styrene acrylic resin in the white ink composition was increased, the ejection stability was not excellent.

The invention is not limited to the embodiments described above, and can be modified in various manners. For example, the invention includes substantially the same configurations (e.g., configurations having the same functions, methods, and results or configurations having the same objects and advantages) as the configurations described in the embodiments. The invention also includes a configuration in which non-essential portions of the configurations described in the embodiments are replaced. The invention also includes a configuration that can demonstrate the same effects or a configuration that can achieve the same objects as those in the configurations described in the embodiments. The invention also includes a configuration in which known techniques are added to the configurations described in the embodiments.

What is claimed is:

1. An ink jet recording method, comprising:
ejecting liquid droplets of a white ink composition to a swelling type target recording medium,
the white ink composition containing a fluorene resin, a styrene acrylic resin, a white pigment, and water.

2. The ink jet recording method according to claim 1, wherein
the target recording medium has a resin layer containing a hydrophilic resin, and
the liquid droplets of the white ink composition are ejected to the resin layer in the ejection process.

3. The ink jet recording method according to claim 2, wherein
the hydrophilic resin is a urethane resin or a cellulose resin.

4. The ink jet recording method according to claim 2, wherein the hydrophilic resin is a urethane resin.

5. The ink jet recording method according to claim 3, wherein the urethane resin is a cationic urethane resin.

6. The ink jet recording method according to claim 3, wherein
the urethane resin or the cellulose resin occupies 80% by mass or more of constituent components of the resin layer.

7. The ink jet recording method according to claim 2, wherein
the target recording medium has a support layer,
the resin layer is formed on at least one side of the support layer, and
the water absorptivity of the support layer is lower than the water absorptivity of the resin layer.

8. The ink jet recording method according to claim 1, wherein
the styrene acrylic resin is contained in a proportion of 1% by mass or more and 10% by mass or lower based on the total mass of the white ink composition.
